(19) United States
(12) Patent Application Publication
(10) Pub. No.: US 2005/0227724 A1
(43) Pub. Date: Oct. 13, 2005

(54) Wireless network and method for determining nearest wireless device

(76) Inventor: Chieh-Chih Tsai, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/709,074

(22) Filed: Apr. 12, 2004

(51) Int. Cl. H04Q 7/20

(52) U.S. Cl. 455/525; 455/67.11

(57) ABSTRACT

A wireless network includes a first wireless device, a second wireless device measuring the signal strength of a signal received at the second wireless device from the first wireless device, a third wireless device measuring the signal strength of a signal received at the third wireless device from the first wireless device, and a fourth wireless device measuring the signal strength of a signal received at the fourth wireless device from the first wireless device. The fourth wireless device selects a nearest wireless device being either the second wireless device or the third wireless device according to the measured signal strengths.

### BACKGROUND OF INVENTION

1. Field of the Invention

The invention relates to wireless networks, and more particularly, to determining which wireless device on a wireless network is nearest to a portable wireless device.

2. Description of the Prior Art

With the increased popularity of wireless networks, it is increasingly desirable to determine which service providing devices are physically closest to a portable wireless device on the wireless network. Furthermore, for certain applications, such as redirecting music playback to the nearest home stereo or redirecting a document to the nearest office printer, a method is needed to not only find nearby devices, but to determine which particular device is the nearest. This determination should be made automatically without user intervention and has been termed “location awareness”.

Location awareness applications are currently undergoing development. Microsoft Research and other academic institutions have done some research based on determining locations of devices in wireless networks. For example, as disclosed by Moore et al. in U.S. Pat. No. 6,664,925, a mobile computer establishes a wireless communication session with a wireless access point of a computer network. The location of each wireless access point is known and obtainable either from a database on the network or from the access points themselves. The strengths of wireless signals passing between the mobile computer and multiple wireless access points of the network, including the access point with which the mobile computer has established the session are measured at multiple time intervals. The measurements may be taken at the mobile computer itself or at the wireless access points. The measured strength values are then weighted according to such factors as whether the mobile computer has already established a communication session with the access point from which the sample was taken, and how old the sample is. For each location, the weighted strength values obtained for access points in that location are summed. The location having the highest sum is deemed to be the location of the mobile computer. However, as this approach requires the locations of the access points to be known in advance and stored in the database, the flexibility of the wireless network is severely limited. Upgrading or modifying the wireless network, therefore, requires the database to be updated, further complicating network maintenance.

Massachusetts Institute of Technology (MIT) has developed the Cricket Location-Support System. This system is disclosed by Priyantha et al. in a paper entitled “The Cricket Location-Support System” published in the “Proc. of the Sixth Annual ACM International Conference on Mobile Computing and Networking (MOBICOM)”, August 2000. A location-support system is described in the paper for in-building, mobile, location-dependent applications. It allows applications running on mobile and static nodes to learn their physical location by using listeners that hear and analyze information from beacons spread throughout the building. Rather than explicitly tracking user location, Cricket helps devices learn where they are and lets them decide whom to advertise this information to; it does not rely on any centralized management or control and there is no explicit coordination between beacons; it provides information to devices regardless of their type of network connectivity; and each Cricket device is made from off-the-shelf components and costs less than U.S. $10. However, as the Cricket system requires additional transmitter beacons and receivers to be included in the wireless network, the cost of the wireless network and associated wireless devices is increased and the design of the wireless network is further complicated.

In U.S. published patent application No. 2003/0220116, Sagefalk et al. disclose a “Method and Apparatus for determining the position of a portable device”. In one embodiment, an apparatus for determining a location of a wireless device in a wireless communication network provided by a plurality of base stations is disclosed. The apparatus comprises a signal strength table and a positioning service module. The signal strength table characterizes signal strengths relative to each of plurality base stations at each of a plurality of locations in the wireless communication network. The positioning service module correlates an actual received signal strength for a communication with the wireless device with at least one of the received signal strengths in the signal strength table, to determine the position of the wireless device. Alternate means and methods are also disclosed for determining the position of the portable device. However, this method and apparatus requires the signal table to include characterized signal strengths at a plurality of locations relative to each of the base stations. If the network topology changes or, for example, if there is a change in the networked area such as a change in the layout of physical objects in the networked area, the signal table must be updated accordingly. This significantly complicates network maintenance and decreases network flexibility.

In U.S. published patent application No. 2004/0022214, Goren et al. disclose a method for locating mobile units based on the use of received signal strength ratio and other criteria. The signal strength of signals transmitted by a mobile unit and received by a plurality of fixed location access points is measured at the access points using the RSSI function of Standard 802.11, and data corresponding to the received signal strength is sent to a computer server over the local area network for comparison to a database, maintained therein, which correlates signal strength to location within the area. It is likewise known to use ratio of signal strength as received by the various access points to compare to a database to determine location. Alternately location may be determined by the computer server based only on ratios of signal strength without using a database. Using the signal strength or the ratio of the signal strengths received at an access point in a wireless network to estimate or compute the location of the mobile unit requires an additional centralized computer server, which increases the network installation and operation costs. Additionally, a second location of the mobile unit is determined based on an absolute value of the detected signal strengths for each of the fixed devices, and the second location must be corrected by a calibration value for each mobile unit. Thus the disclosed prior art wireless network also bears the disadvantages of decreased network flexibility and complicated operational requirements.

In U.S. Pat. No. 6,414,635, Stewart, et al. disclose a “Geographic-based communication service system with more precise determination of a user's known geographic location”. A geographic based communications service system that includes a network and a plurality of access points connected to the network and arranged at known locations in a geographic region. One or more service providers or information providers may be connected to the network to provide services or information on the network. Content provided by the service providers may be based on the known geographic location of the user of a portable computing device (PCD). The known geographic location may be determined with a high degree of precision, using one or more access points and one of several different techniques. In one embodiment, the geographic location of the PCD may be determined within a radius of ten feet. Access points may be configured to determine the bearing of a signal received from a PCD, as well as the strength of the signal transmitted by the PCD. Access points may also be configured to send and receive signals with time stamps. These time stamps may be used to calculate signal travel time, thereby allowing a determination of the distance between an access point and a PCD. Each access point may include location circuitry. The location circuitry may include both analog and digital circuitry configured to perform the various methods used to determine the precise geographic location. However, because the communication service system requires the access points to be arranged at known locations, network flexibility is again decreased.

### SUMMARY OF INVENTION

One objective of the claimed invention is therefore to provide a wireless network and method for determining a nearest wireless device to a portable wireless device, to solve the above-mentioned problems.

According to an exemplary embodiment of the claimed invention, a wireless network is disclosed comprising a first wireless device; a second wireless device measuring the signal strength of a signal received at the second wireless device from the first wireless device; a third wireless device measuring the signal strength of a signal received at the third wireless device from the first wireless device; and a fourth wireless device measuring the signal strength of a signal received at the fourth wireless device from the first wireless device; wherein the fourth wireless device selects a nearest wireless device being either the second wireless device or the third wireless device according to the measured signal strengths.

According to another exemplary embodiment of the claimed invention, a method is disclosed for determining a nearest wireless device in a wireless network. The method comprises providing first, second, third, and fourth wireless devices; measuring the signal strength of a signal received at the second wireless device from the first wireless device; measuring the signal strength of a signal received at the third wireless device from the first wireless device; measuring the signal strength of a signal received at the fourth wireless device from the first wireless device; and determining the nearest wireless device being nearest to the fourth wireless device according to the measured signal strengths, the nearest wireless device being either the second wireless device or the third wireless device.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a first wireless network having a single access point AP according to a first embodiment of the present invention.

FIG. 2 is a diagram of a second wireless network having a single access point AP according to a second embodiment of the present invention.

FIG. 3 is a diagram of a third wireless network having two access points according to a third embodiment of the present invention.

FIG. 4 is a diagram of a fourth wireless network having three access points according to a fourth embodiment of the present invention.

FIG. 5 is a flowchart describing a method of determining a nearest wireless device in a wireless network according to the present invention

### DETAILED DESCRIPTION

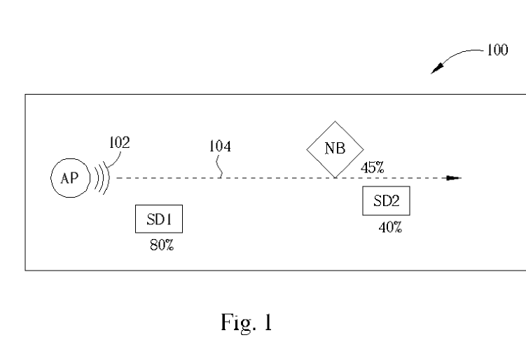

FIG. 1 shows a diagram of a first wireless network 100 having a single access point AP according to a first embodiment of the present invention. The first wireless network 100 includes the single access point AP, a first service providing device SD1, a second service providing device SD2, and a portable notebook computer NB. According to the present invention, the first and second service providing devices SD1, SD2 and the notebook NB are positioned substantially on a line 104 extending from the single access point AP. As an example, assume the user of the portable notebook computer NB wants to redirect a printout to the nearest printer. Also assume the first and second service providing devices SD1, SD2 are two printers on the wireless network 100. In order to determine the nearest device, the first service providing device SD1, the second service providing device SD2, and the notebook computer NB each measure the signal strength of signals 102 received from the access point AP. In this example, as shown in FIG. 1, the first service providing device SD1 measures a signal strength of 80%, the second service providing device SD2 measures a signal strength of 40%, and the notebook computer NB measures a signal strength of 45%. The notebook computer NB uses these measured signal strengths to perform a mathematical analysis to determine which of the service providing devices (either SD1 or SD2) is nearest to the notebook computer NB.

As is well known in the art of radio signals, the signal strength of a received radio signal deteriorates according to the distance between the transmitter and the receiver. As shown in Equations 1 and 2, different signal drop-off rates are experienced in outdoor and indoor conditions.

$$\begin{matrix}s ∝ \frac{1}{{d}^{2}} \text{-} outdoor & Eq . 1 \\ s ∝ \frac{1}{{d}^{3}} \text{-} indoor & Eq . 2\end{matrix}$$

In other words, by comparing the measured signal strengths, it can be determined how far each wireless device is from the access point AP. Because the first and second service providing devices SD1, SD2 and the notebook NB are positioned substantially on a line extending from the single access point AP, the distance of each device from the access point AP can be used to determine the distance of each service providing device SD1, SD2 from the notebook computer NB. In this way, in the example shown in FIG. 1, the notebook computer determines that the second service providing device SD2 is the nearest device.

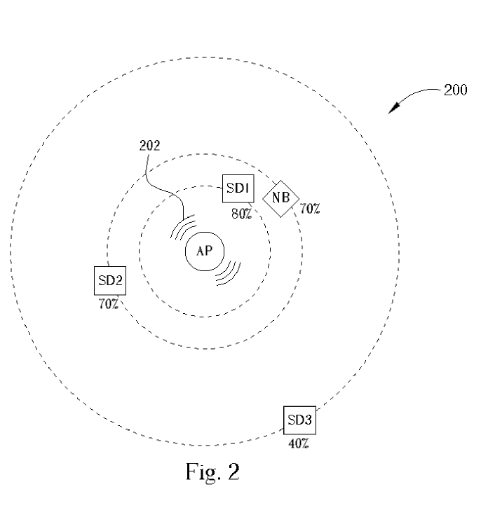

FIG. 2 shows a diagram of a second wireless network 200 having a single access point AP according to a second embodiment of the present invention. The second wireless network 200 includes the single access point AP and wireless devices SD1, SD2, and NB as shown in FIG. 1 in addition to a third service providing device SD3. However, in FIG. 2, the wireless devices are not positioned on a line extending from the single access point AP. Signals 202 transmitted by the access point AP form spheres around the access point AP of different signal strengths. In FIG. 2, the first service device SD1 measures 80% signal strength, the second service device SD2 and the notebook NB measure 70% signal strength, and the third service device SD3 measures 40% signal strength. In this embodiment of the present invention, the notebook provides a suggestion list to the user of the notebook indicating that the first and second service devices SD1, SD2 are most likely closer than the third service device SD3. This is true because the signal strengths measured by the first and second service devices SD1, SD2 are very similar to the signal strength measured by the notebook itself. The user selects the actual nearest service device from the suggestion list and the notebook computer NB stores the user selection so that it can be used as a default device on the suggestion list in the future.

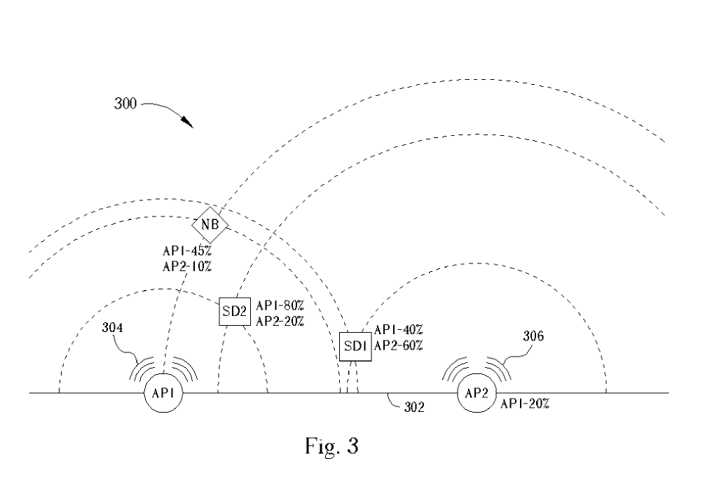

FIG. 3 shows a diagram of a third wireless network 300 having two access points AP1, AP2 according to a third embodiment of the present invention. The third wireless network 300 includes first and second access points AP1, AP2, a first service providing device SD1, a second service providing device SD2, and a portable notebook computer NB. According to the third embodiment, the first and second service providing devices SD1, SD2 and the notebook NB are positioned in an area being to one side of a straight line 302 formed between the first access point AP1 and the second access point AP2. Each wireless device NB, SD2, SD1 measures the signal strength of signals 304, 306 received from the first access point AP1 and the second access point AP2. Additionally, the second access point AP2 measures the signal strength of the signals 304 received from the first access point AP1. In this way, a dynamic coordinate system can be built and (x,y) positions can be calculated for each wireless device.

To calculate the (x,y) positions for each wireless device, firstly note that the position of the notebook NB is given by Equations 3 and 4:
(x_{NB}−x_{AP1})²+(y_{NB}−y_{AP1})²=R_{NBAP1}² Eq. 3
(x_{NB}−x_{AP2})²+(y_{NB}−y_{AP2})²=R_{NBAP2}² Eq. 4
where x_{NB} stands for the x-axis location of the notebook computer, y_{NB} stands for the y-axis location of the notebook computer, x_{AP1} stands for the x-axis location of the first access point AP1, y_{AP1} stands for the y-axis location of the first access point AP1, x_{AP2} stands for the x-axis location of the second access point AP2, y_{AP2} stands for the y-axis location of the second access point AP2, R_{NBAP1} stands for the distance between the first access point AP1 and the notebook computer NB, and R_{NBAP2} stands for the distance between the second access point AP2 and the notebook computer NB. Because the relationship (shown in Equations 1 and 2) between signal strength and distance is known, R_{NBAP1} and R_{NBAP2} can be measured and are assumed to be constants. Additionally, the (x,y) position of the first access point AP1 is defined to be x_{AP1}=0 and y_{AP1}=0, and the y-axis of the second access point AP2 is defined to be y_{AP2}=0. Thus, Equations 3 and 4 simplify to Equations 5 and 6, respectively.
   x_{NB}²+y_{NB}²=R_{NBAP1}² Eq. 5
   x_{NB}²−2x_{NB}X_{AP2}+x_{AP2}²+y_{NB}²=R_{NBAP2}² Eq. 6

Subtracting Equation 6 from Equation 5 and solving for X_{NB} gives Equation 7:

$${x}_{NB} = \frac{( {x}_{AP2}^{2} + {R}_{NBAP2}^{2} - {R}_{NBAP2}^{2} )}{2 {x}_{AP2} } \qquad Eq . 7$$

Thus, the x_{NB} and y_{NB} are related to x_{AP2}, which is determined by the signal strength received from the first access point AP1 at the second access point AP2. In other words, x_{AP2}=±R_{AP2AP1}. Define X_{AP2} to be in the positive direction, and then the (x,y) position of the notebook NB is determined as shown Equation 8.

$$\begin{matrix}{x}_{NB} = \frac{( {R}_{NBAP1}^{2} + {R}_{NBAP2}^{2} - {R}_{AP2AP1}^{2} )}{2 {x}_{AP2} } \\ {y}_{NB} = \pm \sqrt{{R}_{NBAP2}^{2} - {[ \frac{( {R}_{NBAP1}^{2} + {R}_{NBAP2}^{2} - {R}_{AP2AP1}^{2} )}{2 {x}_{AP2}} ]}^{2}}\end{matrix} \} \qquad Eq . 8$$

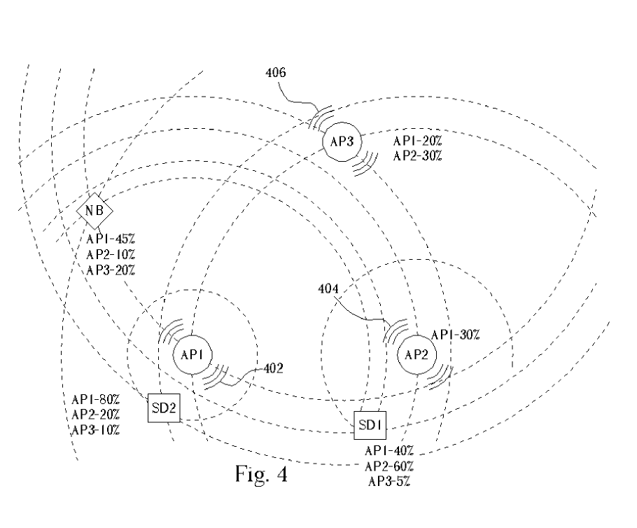

Because, in the third embodiment, the first and second service providing devices SD1, SD2 and the notebook NB are positioned in an area being to one side of the line 302 formed between the access point AP1 and the access point AP2, only the positive y_{NB} value is valid and therefore the position of the notebook NB is known. Similar calculations are performed to determine the specific (x,y) positions for the service providers SD1, SD2. The distance between each service provider SD1, SD2 and the notebook computer NB is then compared and, in this way, the notebook computer NB determines the nearest service provider (SD2 in the example shown in FIG. 4).

If in FIG. 3 the first and second service providing devices SD1, SD2 and the notebook NB are not positioned in an area being to one side of the line 302 formed between the first access point AP1 and the second access point AP2, in another embodiment of the present invention, the notebook NB provides a suggestion list to the user of the notebook NB indicating a plurality of devices which are closer. This can be calculated by assuming all devices are on the same side of the line 302. The user selects the closest device from the suggestion list, and the notebook NB then stores the selection so that the next time it can present the selection as a default choice in the suggestion list.

FIG. 4 shows a diagram of a fourth wireless network 400 having three access points AP1, AP2, AP3 according to a fourth embodiment of the present invention. The fourth wireless network 400 includes three access points AP1, AP2, AP3, a first service providing device SD1, a second service providing device SD2, and a portable notebook computer NB. Each wireless device NB, SD2, SD1 measures the signal strength of signals 402, 404, 406 received from the first access point AP1, the second access point AP2, and the third access point AP3, respectively. Additionally, the second access point AP2 measures the signal strength of signals received from the first access point AP1, and the third access point AP3 measures the signal strength of signals received from the first and second access points AP1, AP2. A mathematical analysis is then performed similar to as described for FIG. 3. As there are three (or more) access points in the fourth embodiment, the wireless devices can be positioned in any desired configuration and the present invention is capable of determining the nearest device. For example, the same process previously described is used to determine the (x,y) position of the notebook computer NB according to the signal strengths received from the first and second access points AP1, AP2. Then, the signal strength measured from the third access point AP3 is used to determine on which side of a line extending between the first and second access points, i.e. to determine the positive or negative sign in Equation 8. Similar calculations are performed to determine the specific (x,y) positions for the service providers SD1, SD2. The distances between each service provider SD1, SD2 and the notebook computer NB are then compared and, in this way, the notebook computer NB determines the nearest service provider (SD2 in the example shown in FIG. 4).

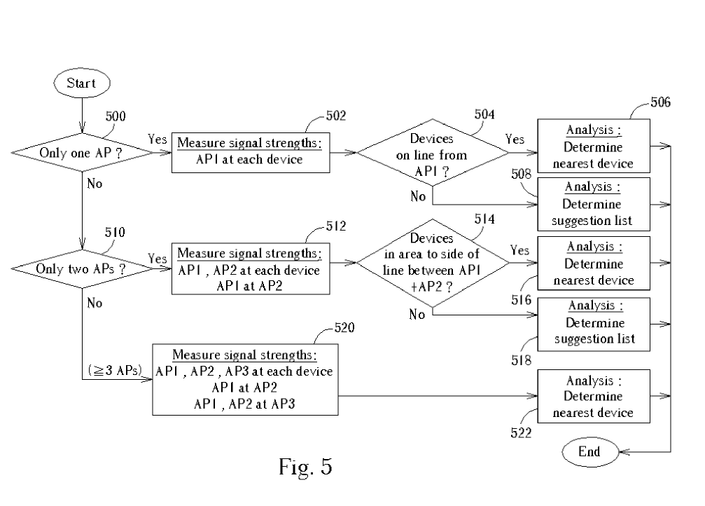

FIG. 5 shows a flowchart describing a method of determining a nearest wireless device in a wireless network according to the present invention. The flowchart contains the following steps:

Step 500: Is there only one access point? If yes, proceed to step 502, otherwise, proceed to step 510.

Step 502: Measure the signal strengths of signals received at each wireless device in the wireless network from the access point.

Step 504: Are the wireless devices in the wireless network positioned substantially on a line originating from the access point? For example, this configuration is useful for wireless devices positioned in a hallway or long narrow room. If yes, proceed to step 506, otherwise, proceed to step 508.

Step 506: Mathematically analyze the signal strengths measured in step 502 to determine the nearest device.

Step 508: Mathematically analyze the signal strengths measured in step 502 to determine a suggestion list of nearest devices.

Step 510: Are there only two access points? If yes, proceed to step 512, otherwise, proceed to step 520.

Step 512: Measure the signal strengths of signals received at each wireless device in the wireless network from each access point. Additionally, measure the strength of signals received at the second access point from the first access point.

Step 514: Are the wireless devices positioned in an area being to one side of a line formed between the first access point and the second access point? For example, this configuration is useful for wireless devices positioned in a rectangular room or beside a wall. If yes, proceed to step 516, otherwise, proceed to step 518.

Step 516: Mathematically analyze the signal strengths measured in step 512 to determine the nearest device.

Step 588: Mathematically analyze the signal strengths measured in step 512 to determine a suggestion list of nearest devices.

Step 520: Measure the signal strengths of signals received at each wireless device in the wireless network from each access point. Additionally, measure the strength of signals received at the second access point from the first access point, and measure the strength of signals received at the third access point from the first and second access points.

Step 522: Mathematically analyze the signal strengths measured in step 512 to determine the nearest device.

It should be noted that the present invention is not limited to a particular method of transferring the signal strengths measured in steps 502, 512, and 520 to the notebook computer to perform the mathematical analysis. In a particular embodiment of the present invention, the signal strengths measured in steps 502, 512, and 520 are stored in a signal table in each wireless device. On each wireless device, a small software server listens on a particular port of the wireless protocol used on the wireless network and provides the measured signal strengths to the notebook computer on demand. For example, HTTP or UPnP servers can be used to provide the notebook access to the measured signals from each wireless device. In this way, the measured signals are stored in a signal table that is disturbed throughout the network. In another embodiment, the measured signals are stored in a signal table that is located in the access point(s). In yet another embodiment, the wireless devices and access points periodically broadcast the measured signal strengths on the wireless network. Additionally, the actual mathematical analysis of the measured signal strengths is not limited to being performed in the notebook computer. The calculation could be performed in another device and then information indicating the nearest device could be transferred to the notebook computer. It is noteworthy that the method for determining the nearest wireless device in a wireless network according to the present invention is applicable to a bluetooth-enabled network or IEEE 802.11 wireless LAN system, as long as the ratio of the signal strength from each wireless device can be measured and compared either by hardware implementation or software operation or a combination of both, regardless of the type of the wireless signal communication protocol used in the wireless network.

It should also be noted that although the present invention has been described in terms of wireless networks having access points, the present invention is not limited to wireless networks having access points. Instead of using access points as reference devices, signals transmit from other wireless devices can also be used. Throughout the description of the present invention, each instance of an access point can be replaced with another wireless device. Additionally, the present invention is not specifically limited to radio signals. Any wireless signal having signal deterioration according to distance can be used with the present invention. Therefore, the present invention is suitable for use with any wireless network.

Those skilled in the art will readily observe that numerous modifications and alterations of the device may be made while retaining the teachings of the invention. Accordingly, the above disclosure should be construed as limited only by the metes and bounds of the appended claims.

1. A wireless network comprising:
a first wireless device;
a second wireless device measuring the signal strength of a signal received at the second wireless device from the first wireless device;
a third wireless device measuring the signal strength of a signal received at the third wireless device from the first wireless device; and
a fourth wireless device measuring the signal strength of a signal received at the fourth wireless device from the first wireless device;
wherein the fourth wireless device selects a nearest wireless device being either the second wireless device or the third wireless device according to the measured signal strengths.

2. The wireless network of claim 1, wherein the measured signal strengths are stored in a single signal table in the first wireless device, stored in a plurality of signal tables distributed among the wireless devices, or periodically broadcast on the wireless network.

3. The wireless network of claim 1, wherein the second, third, and fourth wireless devices are positioned substantially on a line extending from the first wireless device.

4. The wireless network of claim 1, wherein the fourth wireless device determines a plurality of nearest wireless devices.

5. The wireless network of claim 1, further comprising:
a fifth wireless device measuring the signal strength of a signal received at the fifth wireless device from the first wireless device;
wherein the second, third, and fourth wireless devices further measure the signal strength of a signal received at the second, third, and fourth wireless devices from the fifth wireless device, respectively.

6. The wireless network of claim 5, wherein the second, third, and fourth wireless devices are positioned in an area being to one side of a line formed between the first wireless device and the fifth wireless device.

7. The wireless network of claim 5, wherein the fourth wireless device determines a plurality of nearest wireless devices.

8. The wireless network of claim 5, further comprising:
a sixth wireless device measuring the signal strength of signals received at the sixth wireless device from the first wireless device and from the fifth wireless device;
wherein the second, third, and fourth wireless devices further measure the signal strength of a signal received at the second, third, and fourth wireless devices from the sixth wireless device, respectively.

9. The wireless network of claim 8, wherein the first, fifth, and sixth wireless devices are access points; the second and third wireless devices are service providing devices; and the fourth wireless device is a portable device.

10. A method of determining a nearest wireless device in a wireless network, the method comprising:
providing first, second, third, and fourth wireless devices;
measuring the signal strength of a signal received at the second wireless device from the first wireless device;
measuring the signal strength of a signal received at the third wireless device from the first wireless device;
measuring the signal strength of a signal received at the fourth wireless device from the first wireless device; and
determining the nearest wireless device being nearest to the fourth wireless device according to the measured signal strengths, the nearest wireless device being either the second wireless device or the third wireless device.

11. The method of claim 10, further comprising storing the measured signal strengths in a single signal table in the first wireless device or a plurality of signal tables distributed among the wireless devices, or periodically broadcasting the measured signal strengths on the wireless network.

12. The method of claim 10, further comprising positioning the second, third, and fourth wireless devices substantially on a line extending from the first wireless device.

13. The method of claim 10, further comprising determining a plurality of nearest wireless devices.

14. The method of claim 10, further comprising:
providing a fifth wireless device;
measuring the signal strength of a signal received at the fifth wireless device from the first wireless device; and
measuring the signal strength of a signal received at the second, third, and fourth wireless devices from the fifth wireless device, respectively.

15. The method of claim 14, further comprising positioning the second, third, and fourth wireless devices in an area being to one side of a line formed between the first wireless device and the fifth wireless device.

16. The method of claim 14, wherein the fourth wireless device determines a plurality of nearest wireless devices.

17. The method of claim 14, further comprising:
providing a sixth wireless device;
measuring the signal strength of a signal received at the sixth wireless device from the first wireless device and from the fifth wireless device; and
measuring the signal strength of a signal received at the second, third, and fourth wireless devices from the sixth wireless device, respectively.

18. The method of claim 17, wherein the first, fifth, and sixth wireless devices are access points; the second and third wireless devices are service providing devices; and the fourth wireless device is a portable device.
